(19) United States
(12) Patent Application Publication
(10) Pub. No.: US 2025/0042059 A1
(43) Pub. Date: Feb. 6, 2025

(54) HOLDER FOR TILE CUTTER

(71) Applicant: Ishii Tools MFG. Co., Ltd., Miki-shi (JP)

(72) Inventor: Toshikazu ISHII, Miki-shi (JP)

(73) Assignee: Ishii Tools MFG. Co., Ltd., Miki-shi (JP)

(21) Appl. No.: 18/229,383

(22) Filed: Aug. 2, 2023

(51) Int. Cl. B28D 7/04; B28D 1/22

(52) U.S. Cl. CPC B28D 7/04; B28D 1/225

(57) ABSTRACT

This disclosure describes systems, devices, apparatuses, kits, and methods associated with a holder, such as a holder for use with a tile cutting device. In some implementations, holder is configured to be coupled to the tile cutting device. In some implementations, the holder may include or be formed of a polyurethane (PU) material with excellent resiliency enables clean cutting of various types of tiles. In some implementations, the holder is configured to receive a force during splitting of a tile and to distribute the received force to reduce chipping of the tile.

### CROSS REFERENCE TO RELATED APPLICATION

This application is related to Japanese Application Number JP 2022-002751, filed Aug. 2, 2022, registered Dec. 2, 2022, the entire contents of each of which are hereby incorporated by reference.

### TECHNICAL FIELD

The present disclosure relates generally to apparatuses, systems, and methods associated with a tile cutting device, and more particularly, but not by way of limitation, to a holder for a tile cutter device.

### BACKGROUND

Conventional tiles may come in a wide variety of types, such as a hard type or a soft type. A tile cutter, such as a tile cutting machine or a tile cutting device, may be used to cut and/or split a tile. Some tile cutters may be made of or include stainless steel, which may be coupled (e.g., bonded) to other components of the tile cutter. A tile may be placed on a tile cutter (e.g., a portion that includes stainless steel) and the tile may have a cut formed in a surface of the tile. After the cut is formed in the surface of the tile, the tile may be split by exerting a force on the tiles. When the tile is split using the tile cutter, tile edges may be chipped if too much force is exerted. Additionally, or alternatively, for a soft type tile, transversal cracks may occur in a middle of the tile when splitting the tile.

### SUMMARY

The present disclosure is generally related to systems, devices, apparatuses, kits, and methods associated with a holder, such as a holder for use with a tile cutting device. In some implementations, holder is configured to be coupled to the tile cutting device. In some implementations, the holder may include or be formed of a polyurethane (PU) material with excellent resiliency enables clean cutting of various types of tiles. For example, the PU material may enable the holder to distribute a force exerted when splitting different types of tiles to reduce or eliminate chipping of the tile based on the splitting. In some implementations, the holder is configured to receive a force during splitting of a tile and to distribute the received force to reduce chipping of the type. Additionally, or alternatively, the holder, such as the holder including the PU material, may be cut or trimmed to size or shape the holder for use with different tile cutters. To illustrate, the holder may be cut with a knife, scissors, or other sharp edged object, as illustrative, non-limiting examples. In some implementations, a portion of the holder that is damaged may be trimmed off or removed from the holder to enable continued use of the holder.

In some implementations, the holder is coupled to a tile cutter. For example, the holder may be coupled to a rib of the tile cutter, one or more surfaces on either side of the rib, or a combination thereof. A tile to be cut and split may be placed on the tile cutter such that the tile contacts the holder and one or more of the rib, the one or more side surfaces, or a combination thereof. The tile cutter may be operated to form a cut in a surface of the tile. After the cut is made in the surface of the tile, and while the tile is positioned on the holder, a force may be applied to the tile to split the tile. For example, the force may be applied by a component of the tile cutter or by a user (e.g., a hand of a user) of the tile cutter. The force may be transferred to the holder and the force may be distributed by the holder. Distribution of the force by the holder may enable the tile to be easily split, may reduce or prevent chipping of the tile, or a combination thereof. Additionally, or alternatively, the holder may prevent or reduce damage or wear of the rib or the one or more surfaces of the tile cutter, thereby extending a life of the tile cutter or reducing repairs.

Some details associated with the implementations are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the configuration depicted in the figures.

FIGS. 1A and 1B are diagrams of an example of a holder according to one or more aspects.

FIGS. 2A-2F are diagrams of another example of a holder according to one or more aspects.

FIGS. 3A-3F are diagrams of another example of a holder according to one or more aspects.

FIGS. 4A-4F are diagrams of another example of a holder according to one or more aspects.

FIGS. 5A and 5B are pictures of another example of a holder according to one or more aspects.

FIGS. 6A and 6B are diagrams of a system that include a holder and a tile cutter according to one or more aspects.

FIG. 7 is a diagram of the system of FIG. 7 to illustrate a tile splitting operation to split a tile along a cut made in the surface of the tile according to one or more aspects.

FIG. 8 is a diagram of an example of a system for fabricating a holder according to one or more aspects.

FIG. 9 is an example of a kit of a holder according to one or more aspects.

FIG. 10 illustrates a flow diagram of an example of a method of operating a system that includes a holder according to one or more aspects.

### DETAILED DESCRIPTION

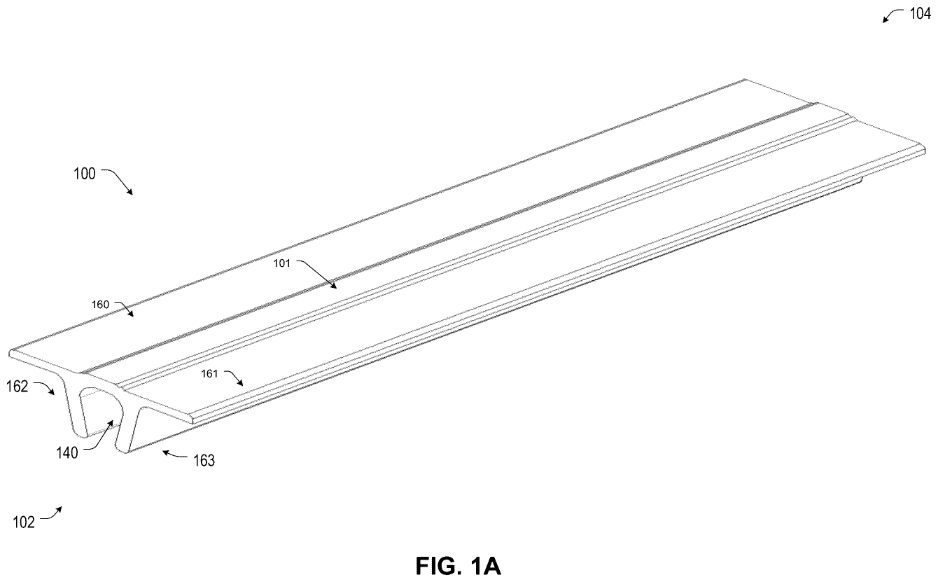

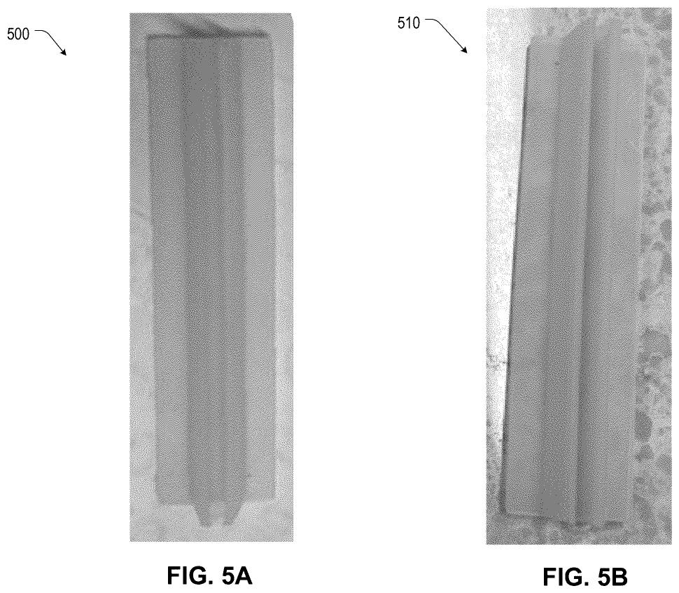

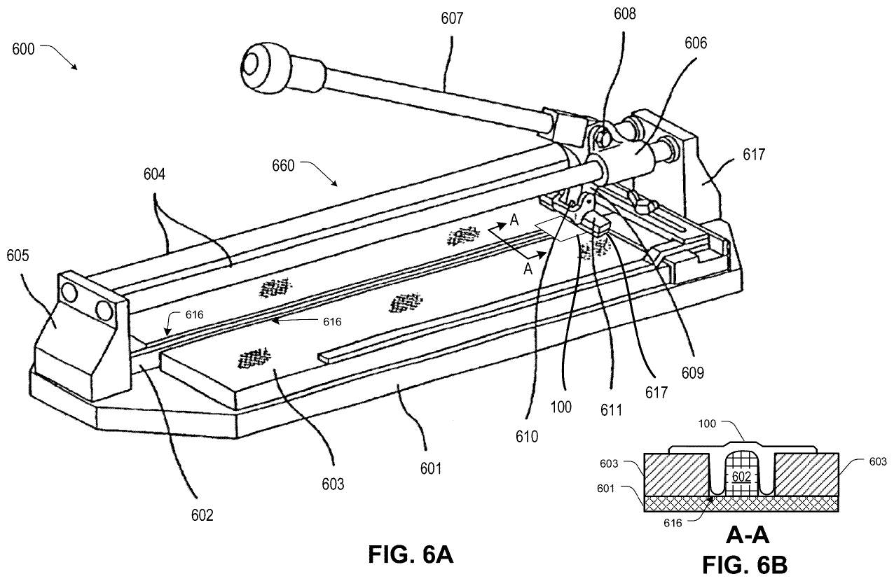

FIGS. 1A and 1B are diagrams of an example of a holder 100 according to one or more aspects. For example, FIG. 1A includes a perspective view a perspective view taken from the front, top and right side of holder 100, and FIG. 1B is a front view of holder 100. Holder 100 may be configured to be coupled to a tile cutter, such as described further herein at least with reference to FIGS. 6A, 6B, and 7. Holder 100 may include or be form from a plastic material. In some implementations, holder may include or be formed from a polyurethane (PU) material.

Holder 100 may extend between a first end 102 and a second end 104. In some implementations, holder 100 is symmetrical about or with respect to a centerline 150. Holder may include one or more portions, such as a body portion 101 a first member 160, a second member 161, a third member 162, and a fourth member 164. In some implementations, first member 160, second member 161, third member 162, fourth member 164, or a combination thereof may extend from body portion 101. Each of first member 160 and second member 161 may be configured to be coupled to a respective surface of a tile cutter (e.g., 660). Each of third member 162 and fourth member 164 may be configured to be coupled to or inserted into a respective channel (e.g., 616) of the tile cutter.

Body portion 101, third member 162, and fourth member 163 may define a channel 140. Channel 140 may extend from first end 102 to second end 104. In some implementations, third member 162 and fourth member 163 define an opening 120 of channel 140. For example, opening 120 may extend along a length of holder 100, such as from first end 102 to second end 104. Channel 140 may be configured to be coupled to or receive a rib (e.g., 602) of the tile cutter. For example, a peak 142 of a curved surface 138 may be configured to contact a top surface of the rib.

Holder 100 may include one or more surfaces. For example, holder 100 may include surfaces 110, 112, 114, 116, 118, 130, 132, 134, 136, 138, 140, 142, 144, and 146. Surfaces 110, 112, 114, 132, 134, 144, and 146 may include or correspond to one or more top surfaces. Surfaces 130 and 142 may include or correspond to one or more end surfaces. Surfaces 116, 118, 136, 138, and 140 may include or correspond to one or more bottom surfaces.

In some implementations, surface 140 is a bottom surface of first member 160 and is configured to contact a surface of the tile cutter. Surface 136 may be a bottom surface of second member 161 and may be configured to contact a surface of the tile cutter. Surface 116 may be a surface of third member 162 and may be configured to contact one or more surfaces that define a channel (e.g., 616) of the tile cutter. Surface 118 may be a surface of fourth member 163 and may be configured to contact one or more surfaces that define a channel (e.g., 616) of the tile cutter. Although one or more surfaces of holder 100 are shown as being planar, such as surfaces 110, 112, 114, 130, 132, 134, 136, 140, 12, 144, 146, in other implementations, at least one of surfaces 110, 112, 114, 130, 132, 134, 136, 140, 12, 144, or 146 may not be planar. Additionally, or alternatively, although one or more surfaces are shown as intersecting and forming edges, in other implementations, two or more surfaces may be joined via a curved or rounded surface. Additionally, or alternatively, one or more surfaces may be omitted or combined.

As shown with reference to FIG. 1B, holder 100 may have one or more dimensions. For example, a first dimension DI may be associated with a distance between surface 110 and surface 140. A second dimension DI may be associated with a distance between surface 112 and surface 140—e.g., a thickness of first member 160. A third dimension D3 may be associated with a width of surface 110. A fourth dimension D4 may be associated with a distance between surface 112 and surface 114. A fifth dimension D5 may be associated with a distance (e.g., a width) between third member 162 and fourth member 163—e.g., of opening 120. In some implementations, fifth dimension D5 may be configured to vary based on third member 162, fourth member 163, or both being moved, such as when third member 162 and fourth member 163 are positioned within channels (616) of a tile cutter. It is noted that third member 162 and fourth member 164 may be biased to a static state/dimension associated with fifth dimension D5. A sixth dimension D6 is associated with a maximum distance (e.g., a maximum width) of channel 140 when third member 162 and fourth member 164 may be biased to a static state/dimension associated with fifth dimension D5. A seventh dimension D7 is associated with a thickness of third member 162 or fourth member 163. An eighth dimension D8 is associated with a thickness of body portion 101 from surface 110 to peak 142 of curved surface 138 of channel 140.

In some implementations, first dimension DI is greater than or equal to eighth dimension D8. Alternatively, first dimension DI may be less than or equal to eighth dimension D8 are equal. In some implementations, fourth dimension D4 is greater than or equal to sixth dimension D6. Alternatively, fourth dimension D4 may be less than or equal to sixth dimension D6. In some implementations, third dimension D3 is greater than or equal to fifth dimension D5. Alternatively, third dimension D3 may be less than or equal to fifth dimension D5.

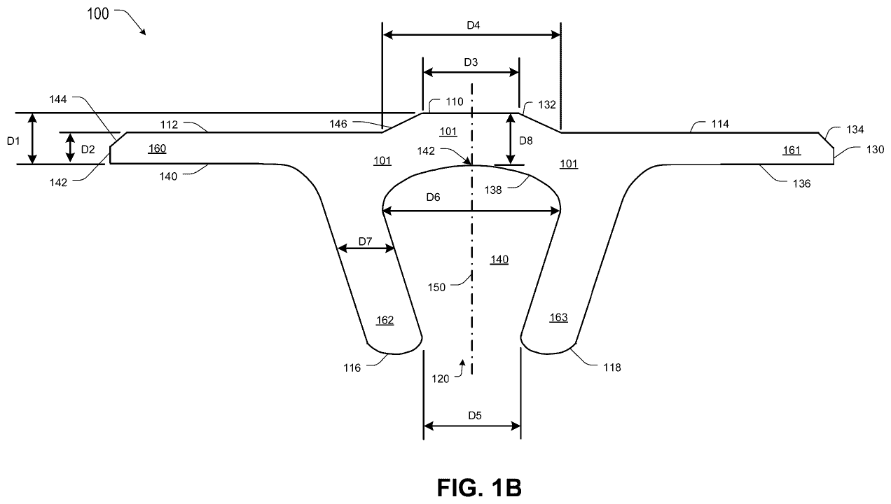

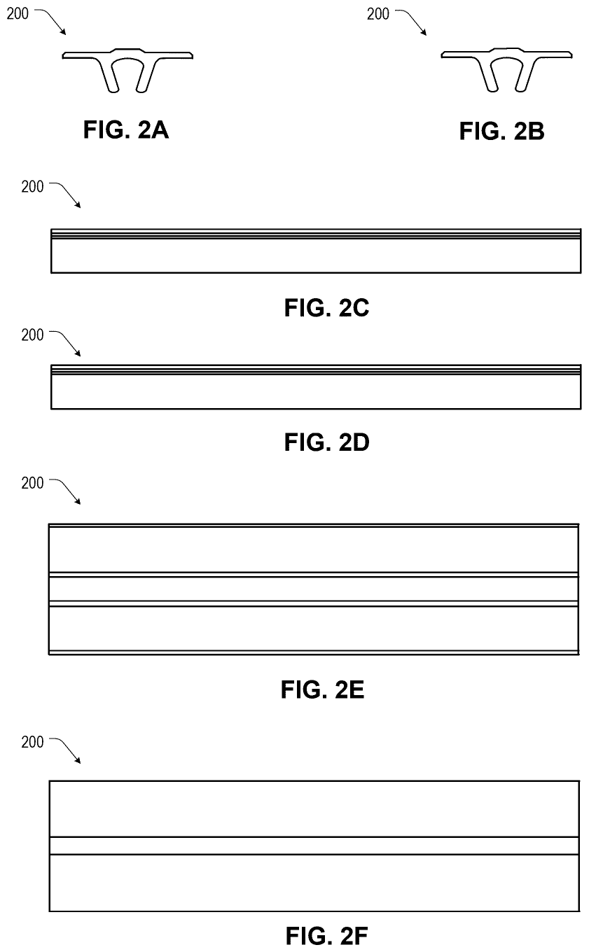

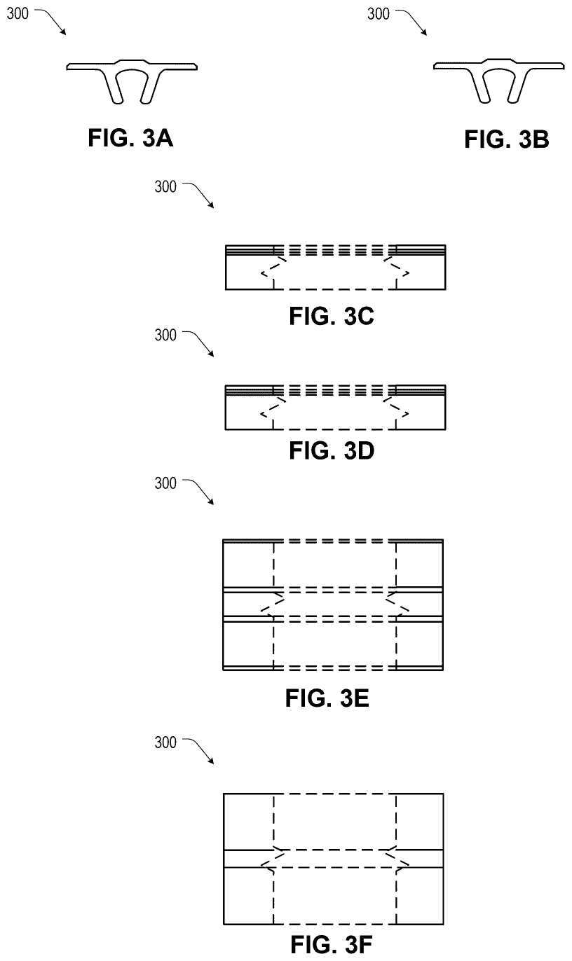

Referring to FIGS. 2A-2F, 3A-3F, and 4A-4F, diagrams of examples of a holder according to one or more aspects are shown. For example, FIGS. 2A-2F include diagrams of an example (or a design) of a holder 200, FIGS. 3A-3F include diagrams of an example (or a design) of a holder 300, and FIGS. 4A-4F include diagrams of an example (or a design) of a holder 400. Holder 200, holder 300, or holder 400 may include or correspond to holder 100. In some implementations, each of holder 200, 300, and 400 may be associated with a different design (or representation of a design) of a holder or a portion thereof.

Referring to FIGS. 2A-2F, FIG. 2A is a front elevational view of holder 200, FIG. 2B is a rear elevational view t of holder 200, FIG. 2C is a right side elevation view of holder 200, FIG. 2D is a left side elevation of holder 200, FIG. 2E is a top plan view of holder 200, and FIG. 2F is a bottom plan view of holder 200. Referring to FIGS. 3A-3F, FIG. 3A is a front elevational view of holder 300, FIG. 3B is a rear elevational view t of holder 300, FIG. 3C is a right side elevation view of holder 300, FIG. 3D is a left side elevation of holder 300, FIG. 2E is a top plan view of holder 300, and FIG. 3F is a bottom plan view of holder 300. Referring to FIGS. 4A-4F, FIG. 4A is a front elevational view of holder 400, FIG. 4B is a rear elevational view t of holder 400, FIG. 4C is a right side elevation view of holder 400, FIG. 4D is a left side elevation of holder 400, FIG. 4E is a top plan view of holder 400, and FIG. 4F is a bottom plan view of holder 400.

With reference to FIGS. 2A-2F, 3A-3F, and 4A-4F, the broken lines (where present) in FIGS. 2A-2F, 3A-3F, and 4A-4F illustrate portions of holder 200, 300, or 400 that form no part of a design of the respective holder (e.g., 200, 300, or 400). Additionally, or alternatively, the break lines (where present) in FIGS. 2A-2F, 3A-3F, and 4A-4F form no part of the respective holder (e.g., 200, 300, or 400) and any portion of the respective holder (e.g., 200, 300, or 400) the break lines forms no part of a design of the respective holder. It is also noted that that one or more solid lines of FIG. 2A-2F, 3A-3F, or 4A-4F may be replaced with one or more broken lines and/or one or more broken lines of FIG. 2A-2F, 3A-3F, or 4A-4F may be replaced with one or more solid lines.

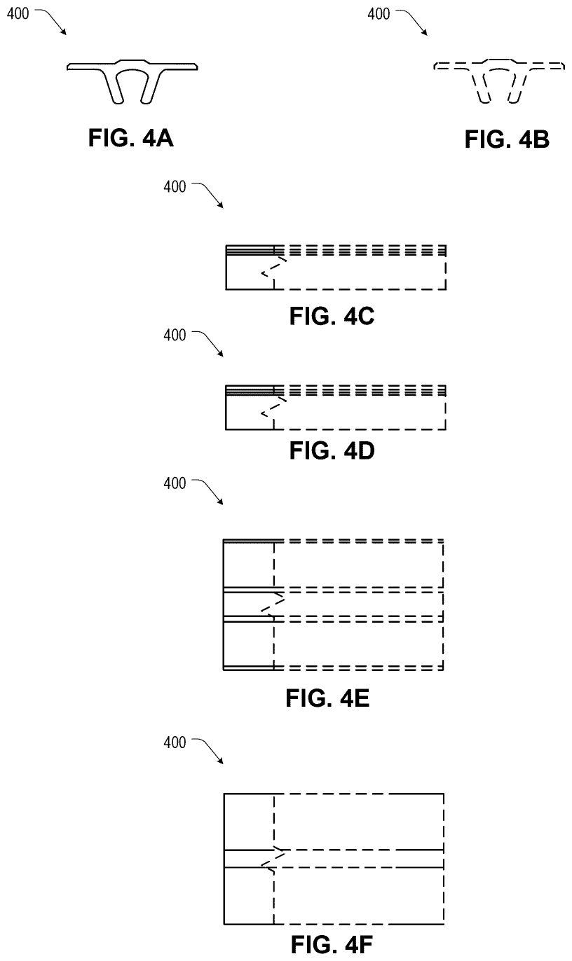

Referring to FIGS. 5A and 5B, FIGS. 5A and 5B are pictures of another example of a holder according to one or more aspects. For example, FIG. 5A shows a first perspective view of a holder 500 from the bottom and the front, and FIG. 5B shows a second perspective view of a holder 510 from the bottom and the rear. Holder 500 or holder 510 may include or correspond to holder 100, 200, 300, or 400.

FIGS. 6A and 6B are diagrams of a system 600 that includes holder 100 and a tile cutter 660 according to one or more aspects. For example, FIG. 6A is a perspective view of system 600, and FIG. 6B is a partial cross-sectional view of system 600 along line A-A. It is noted that tile cutter 660 is an example of a tile cutter device and other tile cutters may be used with holder 100. Holder 100 may include or correspond to holder 100 of FIGS. 1A-1B, holder 200, 300, 400, 500, or 510.

Referring to FIG. 6A, tile cutter 660 includes a base stand 601. Base stand 601 has a substantially rectangular shape when viewed from above. Base stand 601 includes or is coupled tot a protruding rib 602 (herein after referred to as “rib 602”) that is provided in the direction of length of base stand 601. In some implementations, rib 602 is provided in the center of base stand 601. Additionally, or alternatively, rib 602 may include or be formed from steel, such as stainless steel.

Tile cutter 660 also includes sheets 603, such as elastic sheets, which are coupled to base stand 601. For example, sheets 603 may be pasted or otherwise adhered to a surface of base stand 601. Sheets 603 may be coupled to base stand 601 such that rib 602 is positioned between two sheets 603. In some implementation, a top surface of sheets 603 may be slightly lower (in height) than a top surface (or a peak) of rib 602. Stated differently, a height of a sheet 603 with respect to a top surface of base stand 601 may be less than or equal to a height of rib 602 with respect to the top surface of base stand 601. Sheets 603, rib 602, or a combination thereof may be configured to form a tile carrying surface, such as a surface on which a tile (T) is placed for cutting, splitting, or a combination thereof.

Tile cutter 660 also includes guide rails 604, such as two parallel guide rails 604. Guild rails 604 may be supported by a front supporting stand 605 and by a rear supporting stand 612. Front supporting stand 605 may be installed upright on the front (left side in FIG. 6A) end of the base stand 601, and rear supporting stand 612 may be installed upright one rear (right side in FIG. 6A) end of the base stand 601. Guide rails 604 are disposed above the protruding rib 602 in a bridge-like configuration. One or more channels 616 may be formed or defined by base stand 601, rib 602, sheet 603, or a combination thereof. At least one channel 616 may be configured to receive at least a portion of holder 100. In some implementations, holder 100 includes or is made of PU, such as a soft plastic PU, and is coupled to a top of rib 602 which ma be positioned in the middle of base stand 601.

Tile cutter 660 includes a base 606 that is coupled to guide rails 604. Base 606 may be installed or configured so as to move or slide on guide rails 604. A lever 607 (e.g., an operating lever) is coupled to base 606. For example, operating lever 607 may be coupled (e.g., hingedly connected) at point 608 to base 606. Operating lever 607 may include a base portion 609 that extends below guide rails 4.

Base portion 609 may be coupled to a blade 610 (e.g., a rotary blade) and a pressing member 611, which may be provided at a lower end of base portion 609. Blade 610 is configured to make a cut in the surface of a tile (T) placed on base stand 601. Blade 610 may be made of an alloy, such as tungsten carbide. In some implementations, blade 610 includes a double-edged blade, which may have a V shape in cross section is formed around the circumferential edge of blade 610. Blade 610 may be configured to rotate around a shaft (not shown) that is coupled to base portion 609.

Pressing member 611 is configured to press and split a tile place on base stand 601, such as a tile that has been cut by blade 610. Pressing member 611 may be coupled to base portion 609 such that pressing member 611 may be positioned in a first position (e.g., a first state) for a tile cutting operation (using blade 610) and in a second position (e.g., a second state) for a tile splitting operation. For example, pressing member 611 may be hingedly coupled to base portion 609. For example, pressing member 611 may be configured to rotate around a shaft (not shown) that is coupled to base portion 609. In some implementations, pressing member 611 may include one or more pressing pads 617 that are each configured to contact and/or be pressed against a surface of a tile (T)

During operation of system 600, a tile (T) is placed on tile cutter 660 such that tile (T) contacts rib 602, sheet 603, holder 100, or a combination thereof. A cutting operation is performed in which blade 610 begins to be moved while being pressed against the surface of tile (T). To illustrate, lever 607 may be moved downward such that blade 610 is in contact with a surface of tile (T). To contact blade 610 to the surface of tile (T), pressing member 611 is rotated so that blade can contact the surface of tile (T). During the cutting operations, blade 610 is moved across tile (T), such as from a first end of tile (T) toward a second end of tile (T) to form a cut in tile (T). After the cut is formed, a lever 607 is pivoted upward, and blade 610 is lifted from the surface of tile (T). When lever 607 is thus raised, pressing member 611 is lifted (e.g., from the tile surface) and rotates under its own weight—e.g., rotates to a hanging position.

After the cutting operation is performed and a cut is made in the surface of tile (T), a pressing operation may be performed as described further herein at least with reference to FIG. 7. Referring to FIG. 7, FIG. 7 is a diagram of the system of FIG. 7 to illustrate a tile splitting operation to split a tile along a cut made in the surface of the tile according to one or more aspects. For example, FIG. 7 may illustrate operation of lever 607 of tile cutter 660 of FIG. 6 in which lever 607 is pivoted downward (as indicated by arrow 720) so that tile (T) is split along a cut made in a surface of tile (T). To illustrate, lever 607 is pivoted downward such that undersurfaces of pressing member 611 (e.g., at least one pressing pad 617) is in contact with the surface of tile (T).

With pressing member 611 (e.g., at least one pressing pad 617) being in contact with the surface of tile (T), lever 607 is further pivoted down and thus lowered, thereby providing a pressing force to press and split tile (T) into two pieces along the cut. For example, tile (T) may be split into two pieces on the right and left sides of the protruding rib 602. It is noted that holder 100 may enable easy splitting of tile (T) and may reduce or prevent chipping of tile (T). For example, at least a portion or all of the pressing force may be received by holder 100 distributed by holder 100. The distribution of the pressing force by holder 100 may reduce or prevent chipping of tile (T). To illustrate, holder may reduce chipping of tile (T) as compared to tile splitting operation in which holder 100 is not used and the pressing force is applied to tile (T) and tile (T) is pressed against rib 602.

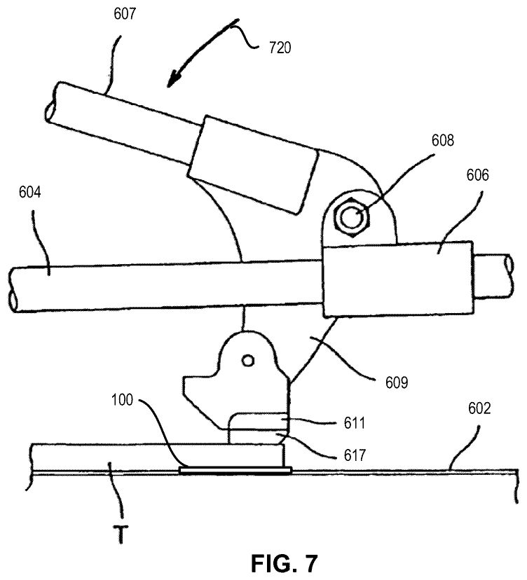

FIG. 8 is a diagram of an example of a system 800 for fabricating a holder (e.g., 100, 200, 300, 400, 500, or 510) according to one or more aspects. In some implementations, system 800 may also be configured to fabricate a tile cutter, such as tile cutter 660, as an illustrative, non-limiting example.

The foregoing disclosed holders (e.g., 100, 200, 300, 400, 500, or 510) (or tile cutters) may be designed and configured into computer files stored on a computer readable media. Some or all of such files may be provided to fabrication handlers who fabricate holders (or tile cutters) based on such files. The holders (or tile cutters) are then packaged and shipped to users for assembly or use, as described above. In some implementations, the holders (or tile cutters) may be shipped in an assembled or partially assembled state.

Holder information 802 is received at a research/design computer 806. Holder information 802 may include design information representing at least one physical property of a holder, such as 100, 200, 300, 400, 500, or 510. For example, holder information 802 may comprise dimensions (e.g., a length, width, height) that is provided, via a user interface 804, to research/design computer 806. Research/design computer 806 includes a processor 808, such as one or more processing cores, coupled to a computer readable medium such as a memory 810. Memory 810 may store computer readable instructions that are executable to cause processor 808 to transform holder information 802 into a design file 812. Design file 812 may include information indicating a design for a holder. Design file 812 may be in a format that is usable by other systems to perform fabrication, as further described herein.

Design file 812 is provided to a fabrication computer 814 to control fabrication equipment during a fabrication process for a material 820 (e.g., PU). Fabrication computer 814 includes a processor 816 (e.g., one or more processors), such as one or more processing cores, and a memory 818. Memory 818 may include executable instructions such as computer-readable instructions or processor-readable instructions that are executable by a computer, such as processor 816. The executable instructions may enable processor 816 to control fabrication equipment, such as by sending one or more control signals or data, during a fabrication process for material 820. In some implementations, the fabrication system (e.g., an automated system that performs the fabrication process) may have a distributed architecture. For example, a high-level system (e.g., processor 816) may issue instructions to be executed by controllers of one or more lower-level systems (e.g., individual pieces of fabrication equipment). The lower-level systems may receive the instructions, may issue sub-commands to subordinate modules or process tools, and may communicate status back to the high-level system. Thus, multiple processors (e.g., processor 816 and one or more controllers) may be distributed in the fabrication system.

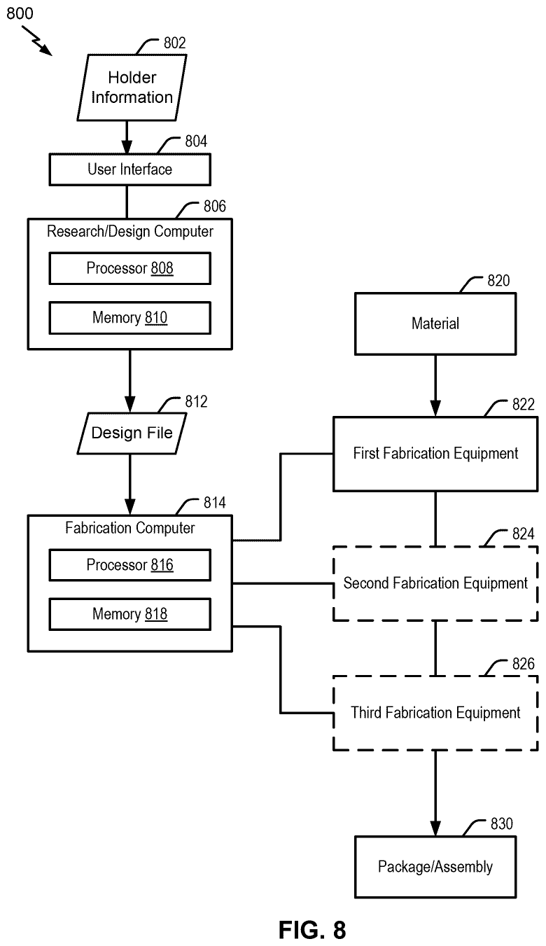

The fabrication equipment includes first fabrication equipment 822, optional second fabrication equipment 824, and optional third fabrication equipment 826. First fabrication equipment 822 is configured to form a holder. In a particular implementation, first fabrication equipment 822 includes first injection molding equipment or an extruder. Second fabrication equipment 824 is configured to cut the holder into multiple holders. Third fabrication equipment 826 is configured to emboss product information on a holder. After first, second, or third fabrication equipment 824, one or more components may be assembled and/or packaged at 830. For example, the one or more components may be packaged into a kit, as described with reference to FIG. 9.

Fabrication computer 814 may be configured to initiate one or more operations of first fabrication equipment 822, second fabrication equipment 824, and/or third fabrication equipment 826. For example, processor 816 may execute instructions stored at memory 818 to perform operations including forming a holder (e.g., 100, 200, 300, 400, 500, or 510).

FIG. 9 is an example of a kit 900 of a holder according to one or more aspects. The holder may include or correspond to holder 100, 200, 300, 400, 500, or 510, or a holder fabricated as described at least with reference to FIG. 8.

Kit 900 includes a holder 902. Holder 902 may include or correspond to holder 100, 200, 300, 400, 500, or 510, or a holder fabricated as described at least with reference to FIG. 8.

In some implementations, kit 900 may alternatively or optionally include a tile cutter 740. Tile cutter 740 may include or correspond to tile cutter 660, as an illustrative, non-limiting example. In some implementations, kit 900 may include holder 902 and tile cutter 940 that are one unit—e.g., holder 902 is coupled to tile cutter 940.

In some implementations, kit 900 may include a package 901. For example, package 901 may include a box, a bag, a container, or the like. Package 901 may include holder 902, tile cutter 940, or a combination thereof. Additionally, or alternatively, package 901 may include a packaging medium (e.g., packaging material), such as foam, paper, or the like.

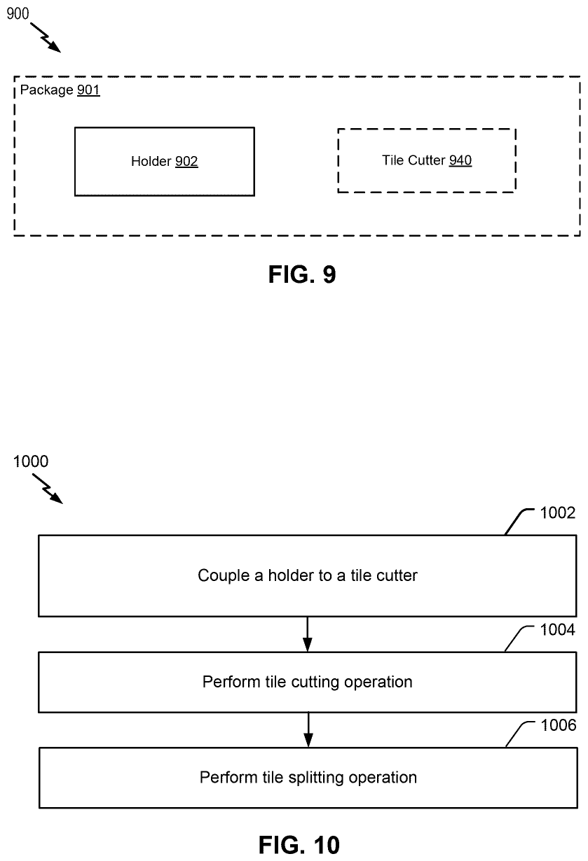

FIG. 10 illustrates a flow diagram of an example of a method of operating a system that includes a holder according to one or more aspects. For example, the handheld device may include or correspond to holder 100, 200, 300, 400, 500, 510, or 902. Method 1000 may be performed at, by, or with holder 100, 200, 300, 400, 500, 510, or 902, a tile cutter (e.g., 650), or a combination thereof.

Method 1000 includes coupling the holder to the tile cutter, at 1002. For example, with reference to holder 100 and tile cutter 650, third member 162 and fourth member 163 may be inserted into channels 616. Additionally, or alternatively, rib 602 may be inserted into channel 140. Holder 100 may be coupled to tile cutter 650 such that surfaces 136 and 140 are in contact with sheets 603.

Method 1000 may also include performing a tile cutting operation, at 1004. For example, a tile may be placed in tile cutter 650 such that the tile is in contact with holder 100. Blade 610 may be operated to form a cut in a surface of the tile.

Method 1000 may also include performing a tile splitting operation, at 1006. For example, a force may be applied to tile to split tile based on the cut formed in the surface of the tile. The force applied to the tile may be transferred to holder 100 and holder may distribute the force. For example, holder 100 may distribute the force to across one or more surfaces of holder 100.

The above specification and examples provide a complete description of the structure and use of illustrative configurations. Although certain configurations have been described above with a certain degree of particularity, or with reference to one or more individual configurations, those skilled in the art could make numerous alterations to the disclosed configurations without departing from the scope of this invention. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes. 1, 1, 5, and 10 percent.

The term “about” as used herein can allow for a degree of variability in a value or range, for example, within 10%, within 5%, or within 1% of a stated value or of a stated limit of a range and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes. 1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementation of any of the systems, methods, and article of manufacture can consist of or consist essentially of-rather than comprise/have/include-any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”.

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

The description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

1. A holder for a tile cutter, the holder comprising:
a body having a top surface;
a first member that extends from the body and is configured to be inserted into a first channel of the tile cutter; and
a second member that extends from the body and has a first bottom surface that is configured to contact a first top surface of the tile cutter, and
wherein the holder includes polyurethane (PU) material.

2. The holder of claim 1, further comprising:
a third member that extends from the body and is configured to be inserted into a second channel of the tile cutter.

3. The holder of claim 2, wherein the body, the first member, and the third member define a channel that is configured to receive a rib of the tile cutter.

4. The holder of claim 1, further comprising:
a fourth member that extends from the body and has a second bottom surface that is configured to contact a second top surface of the tile cutter.

5. The holder of claim 1, wherein the second member extends from the body in a first direction, the fourth member extends from the body in a second direction, and wherein the first direction is opposite of the second direction.

6. The holder of claim 1, wherein, in a state where the holder is coupled to the tile cutter, a top surface of the holder is configured to receive a force and to distribute the force.

7. The holder of claim 5, wherein the force is associated with a tile splitting operation.

8. The holder of claim 1, wherein an entirety of the holder is formed of the PU material

9. A system comprising:
a tile cutter; and
the holder of claim 1 coupled to the tile cutter.
